(19) United States
(12) Patent Application Publication
(10) Pub. No.: US 2015/0367819 A1
(43) Pub. Date: Dec. 24, 2015

(54) AIR JET WINDSHIELD WIPERS FOR VEHICLES

(71) Applicant: Gaurav Bazaz, Edgewater, NJ (US)

(72) Inventor: Gaurav Bazaz, Edgewater, NJ (US)

(21) Appl. No.: 14/311,344

(22) Filed: Jun. 22, 2014

(51) Int. Cl. B60S 1/54

(52) U.S. Cl. CPC B60S 1/54

(57) ABSTRACT

A design for windshield wipers is provided that uses high speed airflow to wipe rain and other elements from the windshield of a vehicle instead of mechanical wipers and in certain cases prevents rain drops from even contacting the surface of the windshield. The invention allows much better visibility than conventional wipers and does much less damage to windscreens than conventional mechanical wipers.

### RELATED APPLICATION

This application claims the benefit of priority to U.S. Provisional Application 61/838,319 filed 23 Jun. 2013, the entire disclosure of which is incorporated by reference.

### BACKGROUND

Almost all vehicles use mechanical wipers to clean the windscreen when rain or other elements such as dirt hit the surface of the windshield. This helps maintain visibility so the driver can see through the windshield clearly. However, there are no alternative models currently available for solving the same problem. Also, mechanical wipers can damage the windscreen over time with friction and also block visibility partially as they only clear part of the screen. In addition, most wipers move in a two stage process whereby they get into position in step one and then move to clear the windshield in step two. This makes the windshield fully visible only part of the time while it has low visibility for the remaining time.

### SUMMARY OF INVENTION

Current windshield wipers utilize mechanical wipers to clear the windshield during rain and when other elements such as dirt or dust deposit on the windshield.

The present invention proposes an alternative model wherein high speed air flow is utilized to clear the windshield. This model can not only clear the elements deposited on the windshield, but also prevent them from contacting the surface in the first place.

The air jet windshield wiper system consists of a high speed air outlet mounted on the car near the bottom of the windshield through which a high speed mass of air, henceforth an air-beam, is released over the windshield. The air-beam is characterized by velocity of its flow, its direction of motion and its shape. The velocity of the air-beam is substantially the average velocity of the air particles in the beam. Similarly, the direction of the air-beam is the direction in which the majority of the air particles in the air-beam are travelling. Finally, the shape of the air-beam is the shape that would be observed close to the outlet, within the proximity of the windshield, if the particles in the air-beam had a color distinct from the surroundings. An air fan, placed separately, draws air from the surrounding regions, routes it through a channel and drives it at a very high speed over the surface of the windshield through the air outlet forming an air-beam emerging from the said outlet. As the air-beam blows over the surface of the windshield, it carries away elements deposited on the windshield with it. In addition, if the device is activated during rainfall, it can carry droplets of rain away from the windshield even before the droplets hit the windshield. With appropriate air speed and air volume, the device can ensure a completely dry windshield even during rainfall. This can allow a tremendous increase in visibility for the driver and occupants of the vehicle.

The air-beam ejected by the outlet is designed so as to cover most of the surface of the windshield and with beam thickness so as to push rain drops all the way over the windshield to the roof of the vehicle and beyond. The thickness of the air-beam is defined in relation to its shape (defined earlier), and is simply the observed width perpendicular to the air-beam direction. The speed of air can be controlled based on requirements by the driver so the device can be operated at high power and lower power levels. It may also be automatically controlled by a combination of sensors and adaptive computer implemented algorithms that modulate the air beam velocity and shape according to requirements, in order to keep the windshield clean and dry. An air beam is defined as the directed mass of air that is ejected from the outlet and generated from the air drawn by the fan. The air beam velocity is controlled by the fan and channel shape. The air beam shape can be controlled by the outlet, which can have actuator controlled flaps that modify the shape of the beam.

In addition, for a moving vehicle, the system can leverage the natural wind flow over the windshield as a supplement to its own wind flow thereby allowing the device to operate at a high power level with lower power consumption. The directed flow of air over the windshield draws in the natural wind flow across the windshield of a moving car, into the direction of flow of the device generated airflow, so the natural wind flow adds to the device generated wind flow. This can be done by having simple metal or plastic flaps near the bottom of the windshield that redirect the flow upwards.

The device can be used alone, or in conjunction with a standard mechanical wiper. The standard mechanical wiper in this configuration could be used to remove sticky debris from the surface of the windshield, when the device wind flow is not effective to remove it.

### BRIEF DESCRIPTION OF DRAWINGS

FIG. 1 shows a simplified view of an automobile with rain falling on the windshield.

FIG. 2 shows a simplified view of the current invention where a high power air stream is run over the windshield to drive away the falling rain from the windshield before it contacts the windshield.

FIG. 3 shows a highly simplified view of the components of the systems, wherein air is drawn in by a fan and passed through a channel to the outlet and ejected from the outlet over the windscreen.

FIG. 4 shows a simplified view of the air jet windshield wiper outlet from the point of view of the driver of the vehicle.

FIG. 5 shows some details for the air jet wiper outlet, with control flaps that control the shape and direction of the air beam ejected from the outlet.

FIG. 6 shows control mechanism for the air jet wiper system.

### DETAILED DESCRIPTION OF THE DRAWINGS

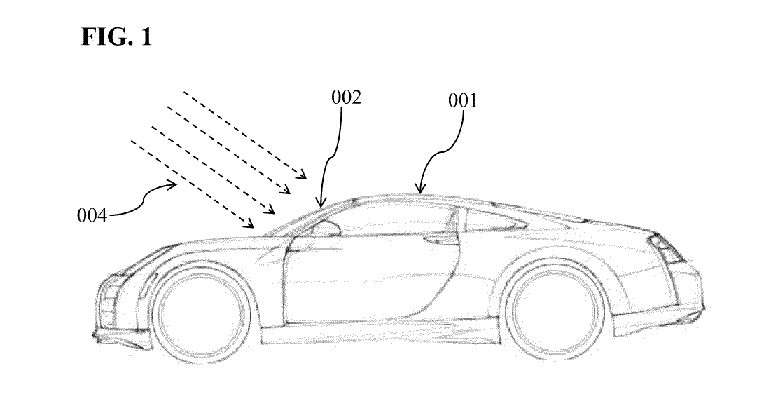

FIG. 1 shows a simplified partial view of an automobile 001 with windshield 002, which has rain 004 falling on it while the automobile is travelling. The rain 004 hits the windshield 002 and makes it wet, thereby distorting vision through the windshield. Windshield wipers run over the surface of the windshield to wipe the water off the windshield which restores visibility. As the wipers run, parts of the windshield are clear and have visibility and other parts are wet and have limited visibility. So the driver has to wait for the wipers to clear the relevant part of the windshield to get full visibility of the road ahead.

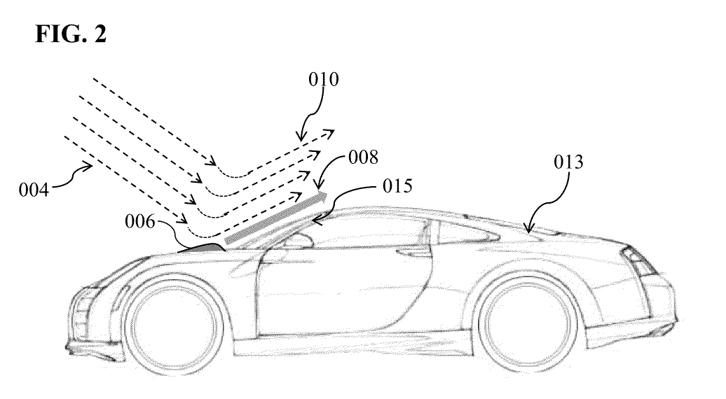

FIG. 2 shows a highly simplified description of current invention. An automobile 013 with windshield 015, drives through the rain 004. An air jet outlet 006 directs a jet of air 008 over the surface of the windshield 015 of the vehicle. As the powerful air jet travels over the surface of the windshield, it carries away the falling rain drops 010 and pushes them over the windshield away from the field of vision of the driver. As a result, the windshield stays completely dry and the driver has complete vision across the entire windshield at all times. As far as the driver is concerned, there is no rain to distort his or her vision anywhere near the car.

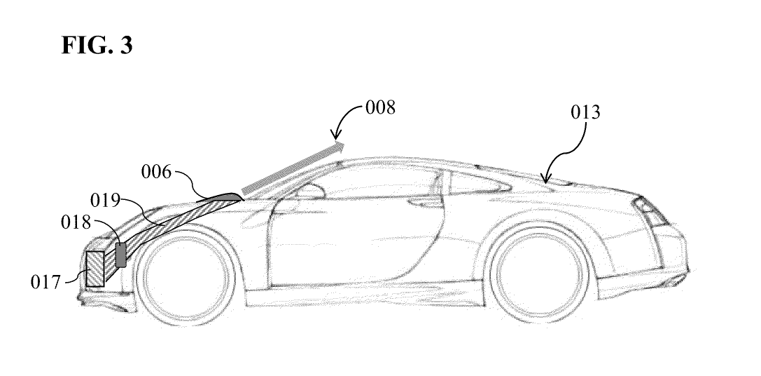

FIG. 3 shows some components of the air jet windshield wiper system. The air jet from the outlet 006 can be generated with any method from machinery placed within the vehicle. In one embodiment, a fan 017 placed within the engine compartment of the vehicle 013, sucks in air from the front grills of the vehicle, runs it through a flow channel 019 while passing it through a filter 018 and then shoots it in a jet out from the outlet 006 over the windshield. In addition, the natural wind flow over the car as it travels through air can be used to supplement the air jet from the outlet. The shape of the outlet, as shown here, can drive the air passing over the vehicle to join the jet of air from the outlet 006, to add more force to the air stream over the windshield.

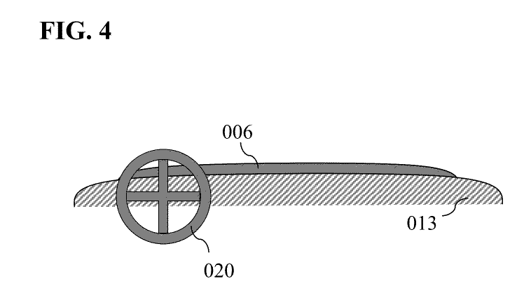

FIG. 4 shows a simplified view of the air jet windshield wiper outlet from the point of view of the driver of the vehicle. The driver sits in front of the steering wheel 020 in the vehicle 013 and can see the air jet windshield wiper outlet 006 over the hood of the car.

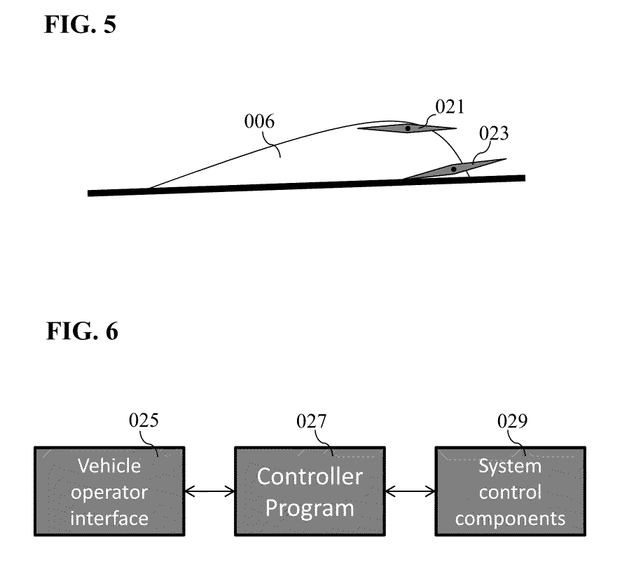

FIG. 5 shows some details for the air jet wiper outlet, with control flaps that control the shape and direction of the air beam ejected from the outlet. The air jet windshield wiper outlet 006 has a lower control flap 023 and upper control flap 021. Each of the flaps can be directed to rotate up or down independently thereby shaping the flow of the wind ejecting from the outlet.

FIG. 6 shows the control mechanism of the air jet wiper system, wherein an interface 025 is provided to the operator of the vehicle, from where the operator can issue instructions like switch on or off, speed up or speed down, direction up or direction down or direction left or direction right and so forth. The signals from the interface system are sent to the controller 027 which processes them and sends translated signals down to specific components 029 of the system in order to achieve the desired change. The controller 027 may be physically and/or logically part of the interface 025 itself.

1. An apparatus to clean the windshield of a vehicle utilizing a high speed mass of air, an air-beam, blown over the surface of the windshield, the apparatus essentially comprising of:
a. a means to draw in air from the surroundings of said vehicle;
b. a tube-like channel through which the air is transmitted;
c. an outlet placed near the bottom of said windshield, on or close to the hood of said vehicle, through which said air drawn in from the surroundings and transmitted through said channel is expelled at a predetermined velocity high enough to dislodge debris such as dust and water deposited on said windshield and directed over the surface of said windshield;
whereby said air-beam ejected from said outlet causes substantially most of debris on said windshield of said vehicle to be expelled from said surface of said windshield and said windshield of the vehicle becomes comparatively clean and dry.

2. The apparatus of claim 1 wherein said tube-like channel includes a filter to filter the air drawn in from the surroundings of said vehicle.

3. The apparatus of claim 1 wherein said means to draw in air from the surroundings of said vehicles is a fan.

4. The apparatus of claim 1 wherein means are provided so that the velocity and shape of said air-beam is in such predetermined configuration that during rainfall, droplets of rain are carried over said windshield before they strike said windshield, such that said windshield is dry even during rainfall.

5. The apparatus of claim 1 further including actuator controlled flaps inside said outlet, which may be controlled by operator of vehicle and by a computer program stored in memory on board the vehicle, said flaps allowing control over the shape of said air-beam.

6. The apparatus of claim 1 further including a control mechanism which allows an operator of said vehicle to control the switching on and switching off of said apparatus, increasing the velocity of said air-beam and controlling the direction of said air-beam.

7. A method to clean a windshield of a vehicle, essentially comprising:
a. providing a means to draw in air from the surroundings of said vehicle
b. providing a tube-like channel to transmit the air drawn in from the surroundings of said vehicle
c. providing an outlet placed near said windshield of said vehicle from where the air drawn in from surroundings of said vehicle is expelled at a predetermined velocity high enough to dislodge debris such as dust and water deposited on said windshield and is directed over the surface of said windshield
whereby said air-beam ejected from said outlet causes substantially most of debris on said windshield of said vehicle to be expelled from said surface of said windshield and said windshield of said vehicle becomes comparatively clean and dry.

8. The method of claim 5 further providing for a filter in the tube-like channel for filtering the air drawn in from the surroundings of said vehicle.

9. The method of claim 5 wherein means to draw in air from the surroundings of said vehicles is provided as a fan.

10. The method of claim 5 wherein the velocity and shape of said air-beam is provided in such a predetermined configuration that during rainfall, droplets of rain are carried over said windshield before they strike said windshield, such that said windshield is dry even during rainfall.
